(19) United States
(12) Patent Application Publication
(10) Pub. No.: US 2025/0286570 A1
(43) Pub. Date: Sep. 11, 2025

(54) METHOD AND APPARATUS OF CALIBRATING NON-LINEAR DISTORTION IN TRANSCEIVER DEVICE

(71) Applicant: MEDIATEK INC., Hsinchu City (TW)

(72) Inventors: Shih-An Yang, Hsinchu City (TW); Yu-Lin Hsieh, Hsinchu City (TW); Chao-Wei Wang, Hsinchu City (TW); Shih-Chieh Yen, Hsinchu City (TW)

(73) Assignee: MEDIATEK INC., Hsinchu City (TW)

(21) Appl. No.: 18/937,035

(22) Filed: Nov. 5, 2024

Related U.S. Application Data
(60) Provisional application No. 63/561,813, filed on Mar. 6, 2024.

(51) Int. Cl. H04B 1/12; H04B 17/11; H04B 17/21; H04L 5/14

(52) U.S. Cl. CPC H04B 1/12; H04B 17/11; H04B 17/21; H04L 5/14

(57) ABSTRACT

A method for calibrating non-linear distortion in a transceiver device is provided. The transceiver device has a transmitter chain and a receiver chain. The method includes: applying a test input signal from the transmitter chain to the receiver chain through a loopback path inside the transceiver device; generating a non-linear distortion model regarding non-linear behavior of the receiver chain based on a test output signal that is produced by the receiver chain in response to inputting of the test input signal; configuring a post distortion processing based on the non-linear distortion model; and performing the post distortion processing on a received signal to generate a compensated received signal.

### CROSS REFERENCE TO RELATED APPLICATIONS

This application claims the benefit of U.S. Provisional Application No. 63/561, 813, filed on Mar. 6, 2024. The content of the application is incorporated herein by reference.

### BACKGROUND

The present invention relates to communications systems, and more particularly, to a method and a related apparatus of calibrating non-linear distortion in a transceiver device

In modern communication systems, increasing the bandwidth of receivers is a common approach to enhance data throughput. However, bandwidth expansion inevitably introduces additional noise (e.g., thermal noises), leading to a reduction in signal-to-noise ratio (SNR) of the system. Such SNR degradation adversely affects the performance of signal demodulation. To mitigate this issue, a conventional strategy involves increasing the power level of the signal in the receivers. Nevertheless, elevating signal power induces non-linear distortions in active components of the receivers, such as low-noise amplifiers and mixers. Consequently, there is a need in the field for an effective correction/compensation mechanism to address non-linear distortion issues in the receivers.

### SUMMARY

With this in mind, it is one objective of the present invention to provide non-linear distortion calibration/compensation techniques for transceiver devices. Specifically, embodiments of the present invention employs post distortion processing techniques to calibrate/compensate for non-linear distortion introduced in the receiver chain of the transceiver device. In consequence, the SNR of the receiver chain can be improved.

The present invention relies upon an internal loopback path within the transceiver device to conduct comprehensive testing of the receiver chain, thereby enabling precise characterization of its non-linear behavior. Based on the accurate characterization, the system can optimally configure the post distortion processing algorithm. The nonlinear distortion calibration/compensation technique provided by the present invention provides significant advantages: it utilizes the transmitter chain to generate a precisely controlled test signal, which is then injected into the receiver chain via an internal loopback path. This method eliminates the need for expensive external test equipment, thereby significantly reducing the hardware and time costs associated with non-linear distortion evaluation.

According to one embodiment, a method for calibrating non-linear distortion in a transceiver device is provided. The transceiver device has a transmitter chain and a receiver chain. The method comprises: applying a test input signal from the transmitter chain to the receiver chain through a loopback path inside the transceiver device; generating a non-linear distortion model regarding non-linear behavior of the receiver chain based on a test output signal that is produced by the receiver chain in response to inputting of the test input signal; configuring a post distortion processing based on the non-linear distortion model; and performing the post distortion processing on a received signal to generate a compensated received signal.

According to one embodiment, an apparatus for calibrating non-linear distortion in a transceiver device is provided. The transceiver device has a transmitter chain and a receiver chain. The apparatus comprises a signal generation unit, a signal measurement and analysis unit and a digital processing unit. The signal generation unit is coupled to the transmitter chain, and configured to generate a digital test signal, thereby allowing the transmitter chain to apply a test input signal from the transmitter chain to the receiver chain through a loopback path inside the transceiver device. The signal measurement and analysis unit is coupled to the receiver chain, and configured to generate a non-linear distortion model regarding non-linear behavior of the receiver chain based on a test output signal that is produced by the receiver chain in response to inputting of the test input signal. The digital processing unit is configurable based on the non-linear distortion model and configured to perform a post distortion processing on a received signal to generate a compensated received signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates portions of a transceiver device according to one embodiment of the present invention.

FIG. 2A illustrates operations of components of a transceiver device and configuration of a switching circuit thereof during non-linearity behavior testing according to one embodiment of the present invention.

FIG. 2B illustrates operations of components of a transceiver device and configuration of a switching circuit thereof during received signal compensation according to one embodiment of the present invention.

FIG. 3 illustrates a flow chart of a method of calibrating non-linear distortion in a transceiver device according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

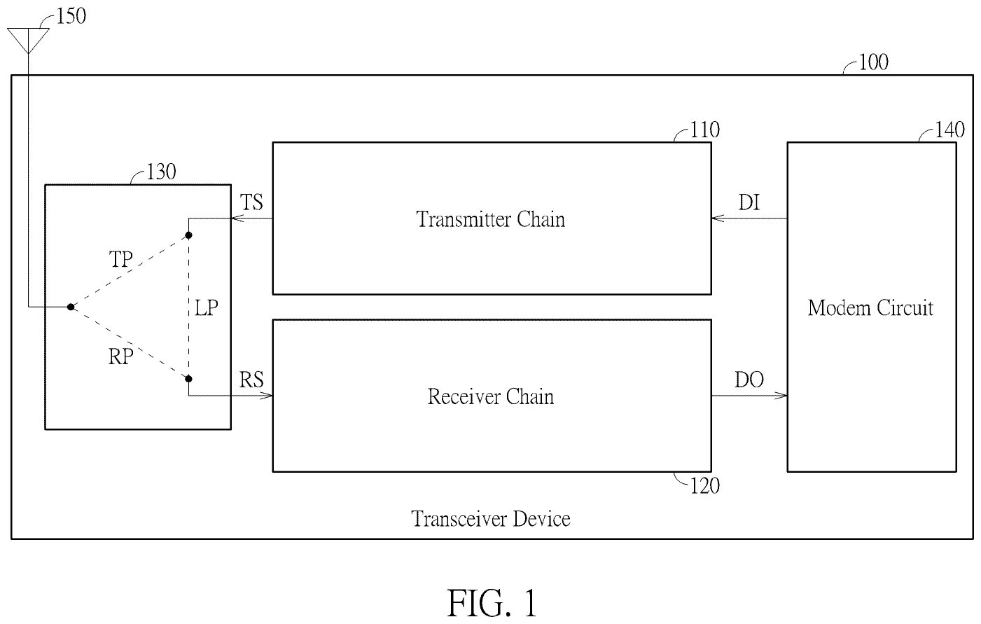

FIG. 1 illustrates portions of a transceiver device according to one embodiment of the present invention. In some embodiments, the transceiver device 100 may be compliant with and operate within a time-division duplexing (TDD) communications system. However, this is not intended to limit the present invention in scope. According to various embodiments of the present invention, the transceiver device 100 may be compliant with and operate within other types of communications systems.

As shown in FIG. 1, the transceiver device 100 comprises a transmitter chain 110, a receiver chain 120, a switching circuit 130 and a modem circuit 140. The transmitter chain 110 and the receiver chain 120 are coupled to the switching circuit 130 and the modem circuit 140, respectively. The switching circuit 130 is coupled to the antenna 150, enabling the transceiver device 100 to alternate between transmission and reception modes. According to various embodiments of the present invention, the transmitter chain 110 may comprise (not shown): digital signal processing circuitry, a digital-to-analog converter, one or more filters, up-conversion circuitry (e.g., a mixer to shift the baseband signal to radio frequency), and/or an amplifier (e.g. a power amplifier to enhance signal strength for transmission). In addition, the receiver chain 120 may comprise (not shown): an amplifier (e.g., a low-noise amplifier to boost the incoming RF signal while minimizing noise), down-conversion circuitry (e.g., a mixer to shift the RF signal to baseband frequency), one or more filters, an analog-to-digital converter, and/or digital signal processing circuitry. The modem circuit 140 may perform functions such as modulation, demodulation, encoding, and decoding.

Typically, the transmitter chain 110 generates a radio frequency (RF) transmit signal TS by processing a baseband digital input signal DI that is sent from the modem circuit 140. The processing in the transmitter chain 110 may include: digital-to-analog conversion, signal filtering, up-conversion, and signal amplification. The RF transmit signal TS is then routed through the switching circuit 130 to the antenna 150 for transmission to a remote device (not shown). On the other hand, the receiver chain 120 processes an RF received signal RS captured by the antenna 150 from a remote device (not shown). The processing in the receiver chain 120 may include: signal amplification, down-conversion, analog-to-digital conversion, and signal filtering. The processing in the receiver chain 120 produces a baseband digital output signal DO, which is then passed to the modem circuit 140 for further processing.

In some embodiments, the switching circuit 130 may be implemented as an enhanced transmit/receive (T/R) switch with additional loopback functionality, which selectively provides: 1) a transmit path TP from the transmitter chain 110 to the antenna 150 during transmit time slots within a signal transmission stage; 2) a receive path RP from the antenna 150 to the receiver chain 120 during receive time slots within a signal reception stage; and 3) a loopback path LP from the transmitter chain 110 to the receiver chain 120 during non-linearity behavior testing.

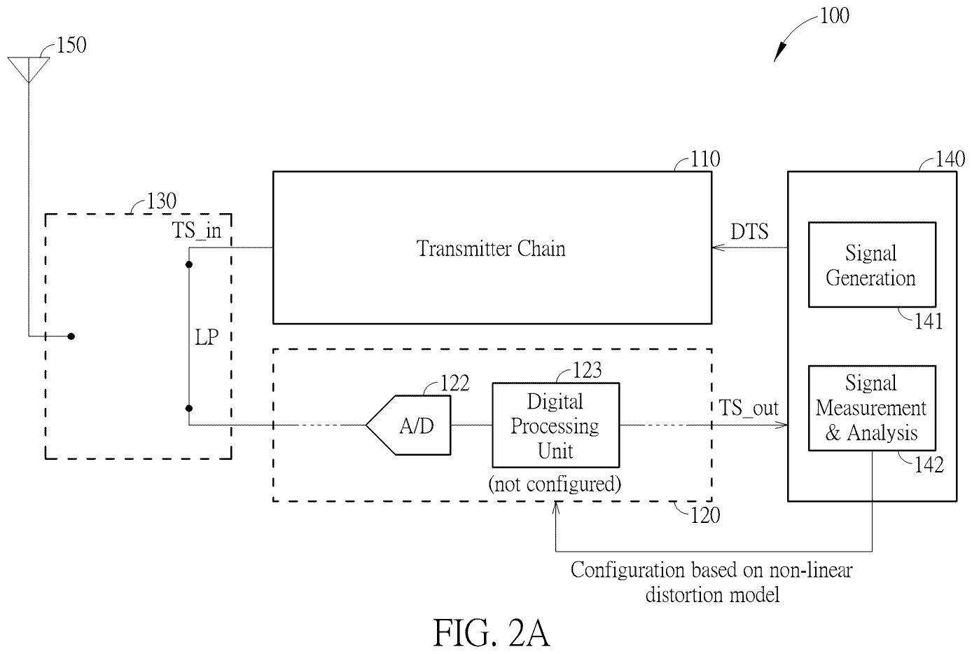

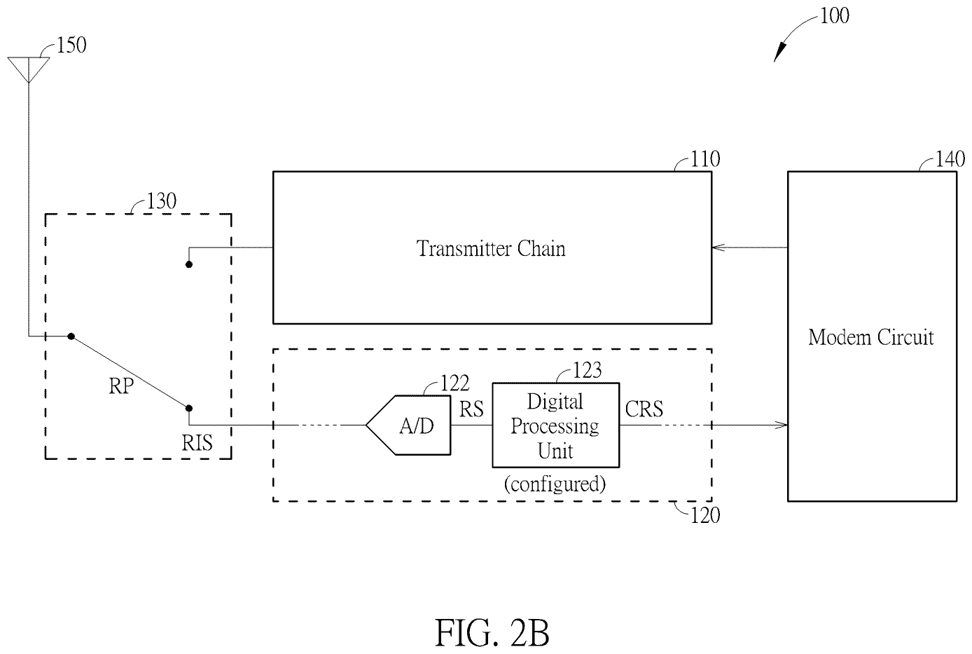

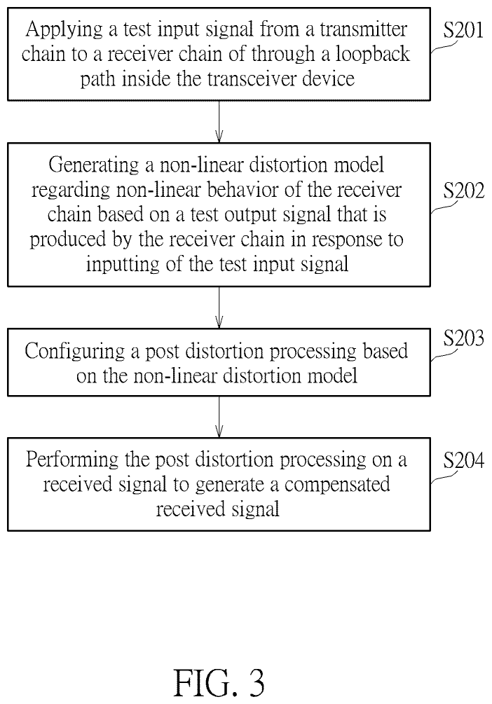

Please refer to FIG. 2A, FIG. 2B, and FIG. 3, which collectively illustrate a method for calibrating non-linear distortion in a transceiver device, along with corresponding operations of key components within the transceiver device. As depicted in FIG. 3, the method comprises the following steps:

Step S201: applying a test input signal from a transmitter chain to a receiver chain through a loopback path inside the transceiver device;

Step S202: generating a non-linear distortion model regarding non-linear behavior of the receiver chain based on a test output signal that is produced by the receiver chain in response to inputting of the test input signal;

Step S203: configuring a post distortion processing based on the non-linear distortion model; and

Step S204: performing the post distortion processing on a received signal to generate a compensated received signal.

At step S201, a test input signal is applied from the transmitter chain to the receiver chain of the transceiver device through a loopback path inside the transceiver device. Specifically, as depicted in FIG. 2A, a signal generation unit 141 in the modem circuit 140 is configured to generate a digital test signal DTS. In some embodiments, the digital test signal DTS may be a predefined digital sequence with known characteristics, designed to test non-linearity behavior of the receiver chain 120. First, the digital test signal DTS is inputted to the transmitter chain 110. In response to the digital test signal DTS, the transmitter chain 110 produces a test input signal TS_in for the purpose of observing the non-linear distortion introduced by the receiver chain 120. At step S201, components in the transmitter chain 110 are carefully controlled. For example, the power amplifier in the transmitter chain 110 is precisely biased and operated at a specific output power level, ensuring the power amplifier operates in a linear region, avoiding any non-linear distortions during the generation of the test input signal TS_in. In view of this, both the digital test signal DTS and the corresponding test input signal TS_in can be considered as known signals with known characteristics. In addition, at step S201, the switching circuit 130 is configured to provide the loopback path LP from the transmitter chain 110 to the receiver chain 120, allowing the test input signal TS_in to be applied to the receiver chain 120.

At step S202, a non-linear distortion model regarding non-linear behavior of the receiver chain is generated based on the test output signal produced by the receiver chain in response to inputting of the test input signal. Specifically, at step S202, the test input signal TS_in is applied to the input of the receiver chain 120 through the loopback path LP. Accordingly, the receiver chain 120 processes the test input signal TS_in through its various processing stages (e.g., signal amplification, down-conversion, filtering, and analog-to-digital conversion), producing a test output signal TS_out. Based on the test output signal TS_out, a signal measurement and analysis unit 142 in the modem circuit 140 is configured to generate a non-linear distortion model. This is accomplished by executing one or more specific algorithms that analyze and characterize relationship between the known digital test signal DTS and the received test output signal TS_out. According to various embodiments of the present invention, the non-linear distortion model could be an amplitude-to-amplitude (AM-AM) distortion model and/or an amplitude-to-phase (AM-PM) distortion model. In some embodiment, the non-linear distortion model may be in form of a polynomial function, an exponential function, a logarithmic function, a trigonometric function or one or more lookup tables, thereby to characterize the overall non-linear behavior of the receiver chain 120, including effects from components such as the amplifiers, the down-conversion circuitry, and/or the analog-to-digital converter in the receiver chain 120.

At step S203, a digital post distortion processing is configured based on the non-linear distortion model. Specifically, a digital processing unit 123 following an analog-to-digital converter 122 in the receiver chain 120 is configured to implement post distortion processing. For example, the post distortion processing is configured based on an inverse function of the non-linear distortion model generated in step S203. In some embodiments, the digital processing unit 123 may be realized through various hardware platforms, including but not limited to: a general-purpose central processing unit (CPU), a specialized digital signal processor (DSP), an application-specific integrated circuit (ASIC), a field-programmable gate array (FPGA), a system-on-chip (SoC) combining multiple processing elements. In some embodiments, the post distortion processing is implemented either in software, firmware, or as a hardware description language (HDL) design, depending on the chosen platform.

At step S204, the post distortion processing is performed on a received signal to generate a compensated received signal. Specifically, as depicted in FIG. 2B, an incoming RF signal (IRS) is captured by the antenna 150 and then sent to the receiver chain 120 through the receive path RP provided by the switching circuit 130 (meaning that the loopback path LP is cut off). In response to inputting of the incoming RF signal IRS, the analog-to-digital converter 122 produces a (digital) received signal RS. Accordingly, the digital processing unit 123 performs the post distortion processing on the received signal RS based on (an inverse function of) the non-linear distortion model, thereby generating the compensated received signal CRS. With the post distortion processing, the non-linear distortion in the receiver chain 120 can be calibrated/compensated, thereby improving the SNR of the output signal of the receiver chain 120.

It is important to note that the configuration of the switching circuit 130 undergoes a transition following the completion of step S201. Specifically, upon completion of S201, the switching circuit 130 is reconfigured to terminate the loopback path LP and establish the receive path RP. This reconfiguration is a prerequisite for the commencement of step S204. The exact timing of reconfiguration may vary depending on the specific implementation and system requirements. For example, the reconfiguration of the switching circuit 130 may occur at step S202 or step S203.

In conclusion, the present invention provides an innovative non-linear distortion calibration/compensation technique for modern transceiver devices. Its core lies in utilizing an internal loopback path and post distortion processing to achieve precise characterization and correction of non-linear behavior in receiver chains. This approach eliminates the need for costly external test equipment while significantly simplifying the calibration process and enhancing the performance of the transceiver device.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for calibrating non-linear distortion in a transceiver device having a transmitter chain and a receiver chain, comprising:
applying a test input signal from the transmitter chain to the receiver chain through a loopback path inside the transceiver device;
generating a non-linear distortion model regarding non-linear behavior of the receiver chain based on a test output signal that is produced by the receiver chain in response to inputting of the test input signal;
configuring a post distortion processing based on the non-linear distortion model; and
performing the post distortion processing on a received signal to generate a compensated received signal.

2. The method of claim 1, further comprising:
providing the loopback path by coupling the transmitter chain to the receiver chain by using a switching circuit.

3. The method of claim 2, wherein the switching circuit further selectively provides a transmit path by coupling the transmitter chain to an antenna of the transceiver device, and selectively provides a receive path by coupling the receiver chain to the antenna.

4. The method of claim 1, further comprising:
performing an analog-to-digital conversion on an output signal generated by at least one amplifier in the receiver chain, thereby to generate the received signal.

5. The method of claim 1, wherein the step of performing the post distortion processing on the received signal to generate the compensated received signal comprises:
performing the post distortion processing on the received signal to generate the compensated received signal when the loopback path is cut off.

6. The method of claim 1, wherein the non-linear distortion model is an amplitude-to-amplitude (AM-AM) distortion model and/or an amplitude-to-phase (AM-PM) distortion model.

7. The method of claim 1, wherein the transceiver device is compliant with and operates within a time-division duplexing (TDD) communications system.

8. An apparatus for calibrating non-linear distortion in a transceiver device having a transmitter chain and a receiver chain, comprising:
a signal generation unit, coupled to the transmitter chain, configured to generate a digital test signal, thereby allowing the transmitter chain to apply a test input signal from the transmitter chain to the receiver chain through a loopback path inside the transceiver device;
a signal measurement and analysis unit, coupled to the receiver chain, configured to generate a non-linear distortion model regarding non-linear behavior of the receiver chain based on a test output signal that is produced by the receiver chain in response to inputting of the test input signal; and
a digital processing unit, configurable based on the non-linear distortion model and configured to perform a post distortion processing on a received signal to generate a compensated received signal.

9. The apparatus of claim 8, further comprising:
a switching circuit, configured to provide the loopback path by coupling the transmitter chain to the receiver chain.

10. The apparatus of claim 9, wherein the switching circuit further selectively provides a transmit path by coupling the transmitter chain to an antenna of the transceiver device, and selectively provides a receive path by coupling the receiver chain to the antenna.

11. The apparatus of claim 8, wherein the receiver chain further comprises an analog-to-digital converter and the analog-to-digital converter performs an analog-to-digital conversion on an output signal generated by at least one amplifier in the receiver chain, thereby to generate the received signal.

12. The apparatus of claim 8, wherein the digital processing unit is configured to perform the post distortion processing on the received signal to generate the compensated received signal when the loopback path is cut off.

13. The apparatus of claim 8, wherein the non-linear distortion model is an amplitude-to-amplitude (AM-AM) distortion model and/or an amplitude-to-phase (AM-PM) distortion model.

14. The apparatus of claim 8, wherein the transceiver device is compliant with and operates within a time-division duplexing (TDD) communications system.
